(19) United States
(12) Patent Application Publication
(10) Pub. No.: US 2004/0232713 A1
(43) Pub. Date: Nov. 25, 2004

(54) Simple handle, designed and built, to quickly grip; easily and safely carry; and then quickly release, wire mesh coated building panels

(76) Inventor: Earl Raymond Littleton, Pearland, TX (US)

Correspondence Address: EARL LITTLETON, 1920 O'DAY RD., PEARLAND, TX, 77581, US

(21) Appl. No.: 10/443,716

(22) Filed: May 23, 2003

(51) Int. Cl. B65G 7/12

(52) U.S. Cl. 294/15

(57) ABSTRACT

The usefulness of an item or a process is largely a function of the cost it saves. This handle allows the heavy panels to be moved and carried by very young volunteers workers, virtually children. As a result, very poor children can do the work of building a house for a very poor senior citizen.

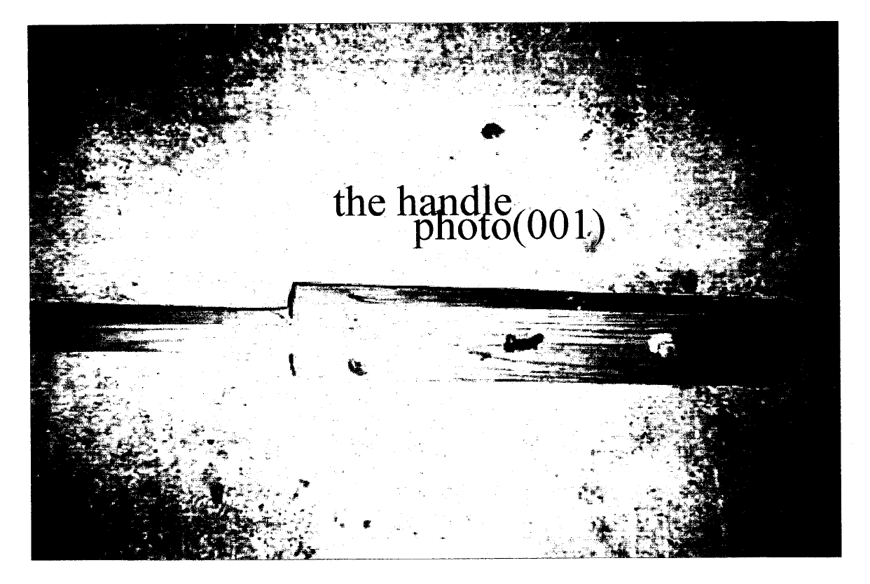

### CROSS REFERENCE TO RELATED APPLICATIONS

NON-APPLICABLE

### STATEMENT REGARDING FEDERALLY SPONSORED RESEARCH OR DEVELOPMENT

NON-APPLICABLE

### BACKGROUND OF THE INVENTION

The manufacturer of wire mesh building panels warns: “Gloves should always be worn when handling these products.” Indeed so! Even though I was wearing heavy leather gloves when I lifted such a panel in the fall of year 2002, the 14-gage wire pressed painfully into my skin. Vaguely, my mind recalled the time, many years ago, when I felt similar pain. On the farm where I was raised, the heavy baskets had wire loop handles. These wire loops would painfully press into my skin when the basket was lifted. To prevent this, my sister and I would pass the round wooden handle of a garden hoe through the wire loop handles and lift the baskets with this wooden handle. As I carried the wire mesh building panel, I realized I was forced to walk with my toes under the panel. If the panel dropped, it would fall on my toes. In a flash of insight, I pictured a Wooden handle that would spare my hands from the wire and also allow me to safely step back from the load I was carrying.

### BRIEF SUMMARY OF THE INVENTION

There are two basic ideas behind this patent:

Build a handle that will quickly and firmly attach to the wire of the panel so that a worker can hold onto the handle instead of the thin 14-gage wire.

Construct the handle so that no matter how it is attached to the panel, the feet and legs of the worker need never be placed under the panel while carrying it.

That is to say, the handle will project a safe distance away from the panel.

### DETAILED DESCRIPTION OF THE INVENTION

Measure and cut a two by four 36 inches long, you then cut two 1 inch by 12 in long on both sides of one end leaving two 1 inch by 12 inch handle on the bat. You then bore 3 holes down the center of the remaining 24 inches of the bat; these holes should be spaced apart where all three will fit into the 2-inch by 2-inch spaces of the wire-covered panel. The holes should be ½ inch to receive a ½ inch bolt you place this in holes with three nuts and four washers. The center hole should be filled with a ½ inch bolt as well with only 2 nuts and 3 washers then heat the bolt to bend it at a 45-degree angle then one inch from this a 60 degree angle. See photo (001). This is to grasp the wire mesh on the 3-d panels.

You will then sand the handle part of the bat and round off the corners. You can bore a small hole in the top of the bat to hang it with when not in use.

1. What I claim as my invention is a simple handle designed and built, to quickly grip: easily and safely carry: and then quickly release, wire mesh coated building panels
